(19) United States
(12) Patent Application Publication
(10) Pub. No.: US 2009/0188727 A1
(43) Pub. Date: Jul. 30, 2009

(54) Apparatus For Processing Signals From Electromagnetic Antenna Board With Multiple Processing Units

(76) Inventor: Yun-Hsiang Yeh, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/019,624

(22) Filed: Jan. 24, 2008

(51) Int. Cl. G06F 3/041; G06K 11/06; G08C 21/00

(52) U.S. Cl. 178/20.01

(57) ABSTRACT

An apparatus with multiple processing units is provided for processing signals from one or more electromagnetic antenna board in a concurrent and/or cooperative manner. The apparatus of the present invention includes a plurality of signal processing units, each connected to a different or same electromagnetic antenna board, and an integration processing unit connected to each of the signal processing units. The signal processing units process the signal from the connected antenna board independently, if connected to different antenna board, or cooperatively, if connected to the same antenna board. The result of the processed signals are then fed to the integration processing unit, which will perform further processing to obtain the final output signals.

### FIELD OF THE INVENTION

The present invention generally relates to an apparatus for processing signals from an electromagnetic antenna board, and more specifically to an apparatus with multiple processing units for processing signals from an electromagnetic antenna board.

### BACKGROUND OF THE INVENTION

The conventional electromagnetic antenna board is usually used in the digital board for receiving made up of an electromagnetic pen and a writing board. The writing board usually includes a two-dimensional antenna for sensing the electromagnetic signals applied by the user and a signal processing unit for processing the sensed signal.

FIG. 1 shows a schematic view of a conventional electromagnetic antenna board with a single signal processing unit. As shown in FIG. 1, an antenna board 101 is connected to a signal processing unit 103. Signal processing unit 103 further includes a signal amplifier 1031, a signal filter 1033, a charge/discharge circuit 1035, a frequency divider 1037 and a microprocessing unit (MCU) 1039. Signal amplifier 1031 is for receiving and amplifying the electromagnetic signal sensed by antenna board 101. The amplified signal is then filtered by signal filter 1033 to obtain the filtered signal. The filtered signal is then fed to charge/discharge circuit 1035 to obtain the digital signal and to frequency divider 1037. The digital signal from charge/discharge circuit 1035 and the signal from frequency divider 1037 are fed to MCU 1039 for conversion to coordinates 105 and pressure 107, respectively. Both coordinates 105 and pressure 107 can be outputted through and RS-232 or USB for further processing or application.

However, the performance issue of the conventional antenna board with a single signal processing unit prevents the conventional antenna board from being applied to a wider range of possible applications. For example, the single signal processing unit can only process so much information in a fixed period of time; therefore, only a limited amount of computation or functions may be performed on the sensed input signal. This limits the application of the antenna board. For instance, when the antenna board is large, a single signal processing unit may takes longer time to process the signal to obtain the coordinates or the pressure of the sensed signal. Or, a single signal processing unit may process only a limited amount of information of a sensed signal. Thus, most of the conventional antenna board only performs functions, such as computing coordinates and pressure of the signal, and the computation is only to a certain precision.

On the other hand, if more signal processing power is available, the additional signal processing, such as higher precision in signal computation, pressure tilting angle, and so on, can also be obtained and applied to a wider range of applications. It is therefore imperative to develop an apparatus with more signal processing power to process signals from an electromagnetic antenna board so that more applications can be achieved.

### SUMMARY OF THE INVENTION

The present invention has been made to overcome the above-mentioned drawback of conventional electromagnetic antenna board with a single signal processing unit. The primary object of the present invention is to provide an apparatus with higher processing power for processing signals from an electromagnetic antenna board to improve the signal processing performance so as to achieve higher computation precision.

Another object of the present invention is to provide an apparatus with higher processing power for processing signals from an electromagnetic antenna board so as to provide additional signal processing functions.

Yet another object of the present invention is to provide an apparatus with higher processing power for concurrently or cooperatively processing signals from a plurality of electromagnetic antenna boards.

To achieve the above objects, the present invention provides an apparatus with multiple processing units for processing signals from one or more electromagnetic antenna board in a concurrent and/or cooperative manner. The apparatus of the present invention includes a plurality of signal processing units, each connected to a different or same electromagnetic antenna board, and an integration processing unit connected to each of the signal processing units. The signal processing units process the signal from the connected antenna board independently, if connected to different antenna board, or cooperatively, if connected to the same antenna board. The result of the processed signals are then fed to the integration processing unit, which will perform further processing to obtain the final output signals.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional electromagnetic antenna board with a single signal processing unit;

FIG. 2 shows a schematic view of an apparatus with multiple signal processing units for processing signals from electromagnetic board of the present invention;

FIG. 3 shows a schematic view of an embodiment of signal processing unit of the apparatus with multiple signal processing units of the present invention;

FIG. 4 shows a schematic view of an embodiment of integration processing unit of the apparatus with multiple signal processing units of the present invention;

FIG. 5 shows a schematic view of a first application of the apparatus with multiple signal processing units of the present invention to a plurality of antenna board; and

FIG. 6 shows a schematic view of a second application of the apparatus with multiple signal processing units of the present invention to a single antenna board.

### DETAILED DESCRIPTION OF THE PREFERRED EMBODIMENTS

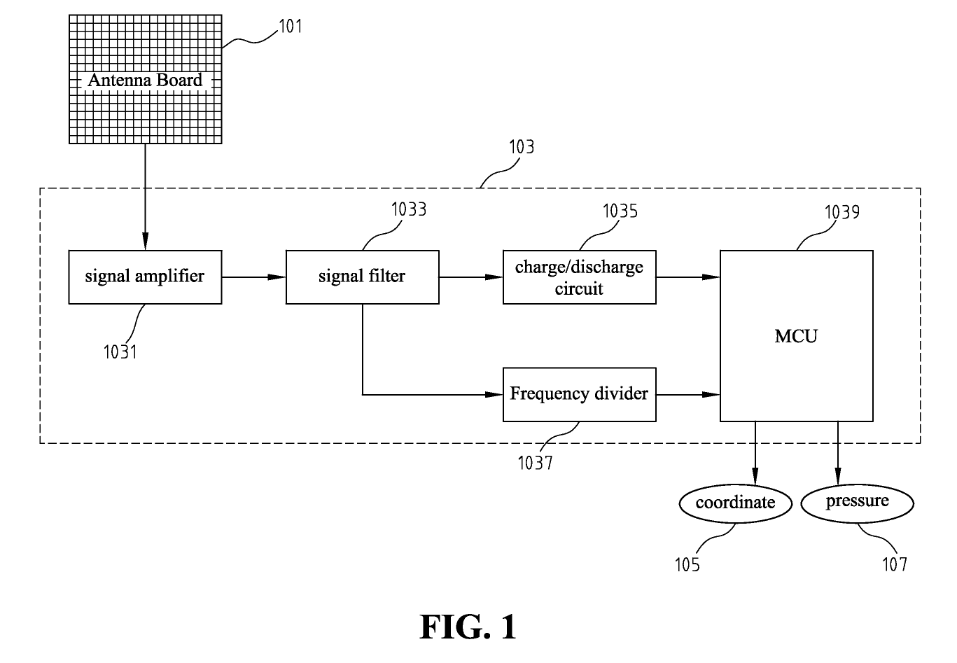

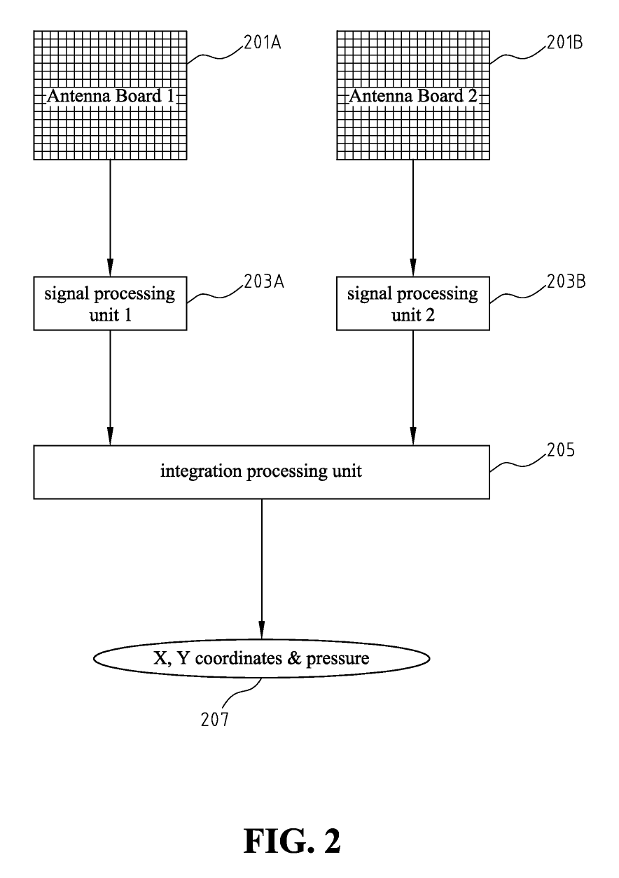

FIG. 2 shows a schematic view of an apparatus with multiple signal processing units for processing signals from electromagnetic board of the present invention. Without the loss of generality, the embodiment shown in FIG. 2 includes only two signal processing units, with each signal processing connected to a separate antenna board. Additional signal processing units can also be included. As shown in FIG. 2, an apparatus with multiple signal processing units of the present invention includes a plurality of signal processing units 203A, 203B, and an integration processing unit 205. Signal processing units 203A, 203B are connected to antenna board 201A, 201B respectively for receiving and processing signals from antenna board 201A, 201B respectively. Signal processing units 203A, 203B are similar to the conventional signal processing unit connected an antenna board of FIG. 1, except that output signals from signal processing units 203A, 203B may include coordinates, antenna digital signal, pressure, frequency, ID, and so on. Also, all the output signals are further fed to integration processing unit 205.

Integration processing unit 205 is connected to all signal processing units 203A, 203B for receiving and integrating processed signal to compute for final output 207, such as X-Y coordinates and pressure shown in the embodiment of FIG. 2. Integration processing unit 205, after receiving output signals from each single processing unit, can integrate each signal in different manner to product final output 207. For example, all the coordinate signal and the pressure signal from all the signal processing units may be integrated to obtain the final TABLET information, the INK information, or any other specific information for output.

As signal processing units 203A, 203B are connected to different antenna board in this embodiment, the signal processing units can process the signals from the antenna boards in the concurrent and independent manner to provide higher performance.

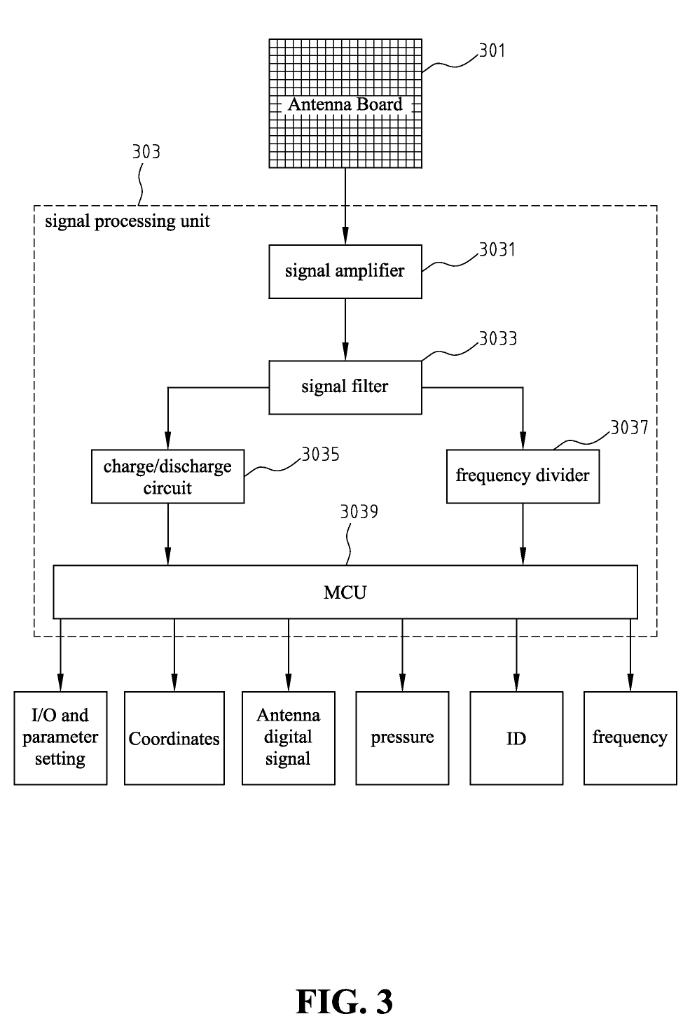

FIGS. 3 & 4 show the details of the signal processing unit and the integration processing unit of FIG. 2 respectively.

FIG. 3 shows a schematic view of an embodiment of signal processing unit of the apparatus with multiple signal processing units of the present invention. As shown in FIG. 3, signal processing unit 303 further includes a signal amplifier 3031, a signal filter 3033, a charge/discharge circuit 3035, a frequency divider 3037, and an MCU. Signal amplifier 3031 receives and amplifies the electromagnetic signal sensed by antenna board 301. Signal filter 3033 then receives and filters the amplified signal from signal amplifier 3031. The filtered signal is then fed to charge/discharge circuit 3035 and frequency divider 3037, respectively. The filtered signal fed to charge/discharge circuit 3035 for the analog-to-digital conversion can obtain the digital signals of each antenna, which are then converted by MCU 3039 to obtain the coordinates of the location on the antenna board. The filtered signal fed to frequency divider 3037 can be computed by MCU 3039 to obtain corresponding frequency, which can be further converted to pressure and ID. In addition to the conventional coordinates and pressure output, MCU 3039 may also output I/O and parameter setting, antenna digital signal, ID, frequency, and so on, as shown in FIG. 3.

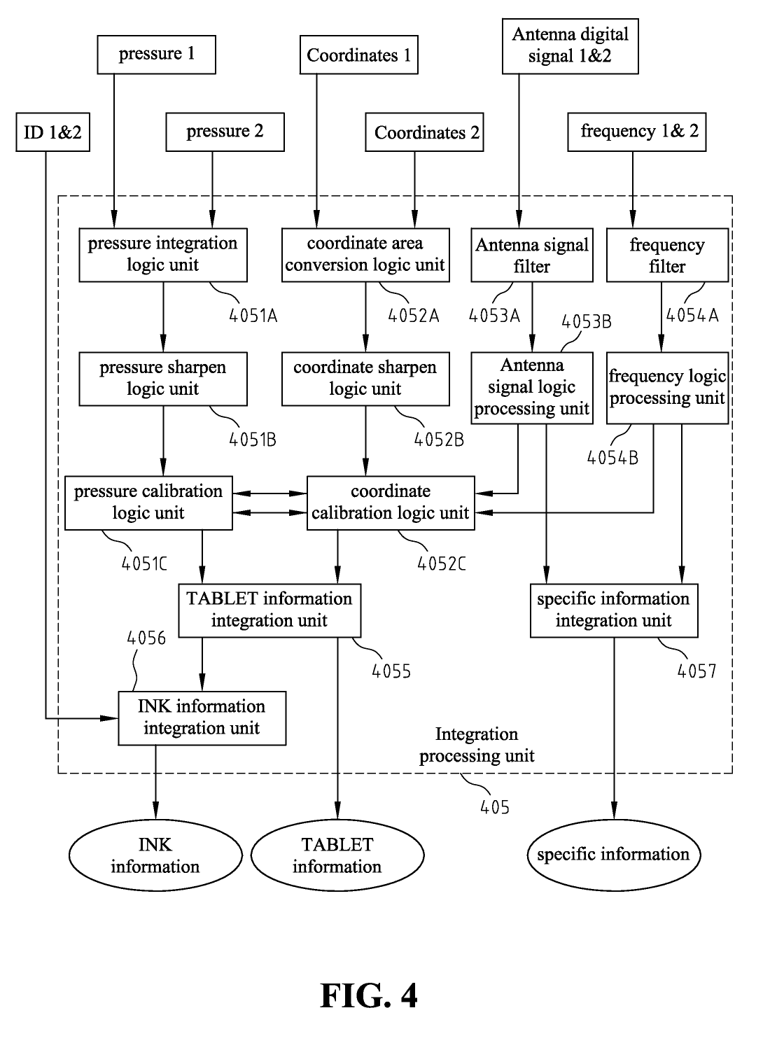

FIG. 4 shows a schematic view of an embodiment of integration processing unit of the apparatus with multiple signal processing units of the present invention. The output signals from each signal processing unit, such as ID, pressure, and so on, are then fed to integration processing unit 405 for integration. Integration processing unit 405 includes a pressure integration logic unit 4051A, a pressure sharpen logic unit 4051B, a pressure calibration logic unit 4051C, a coordinate area conversion logic unit 4052A, a coordinate sharpen logic unit 4052B, a coordinate calibration logic unit 4052C, an antenna signal filter 4053A, an antenna signal logic processing unit 4053B, a frequency filter 4054A, a frequency logic processing unit 4054B, a TABLET information integration unit 4055, an INK information integration unit 4056, and a specific information integration unit 4057.

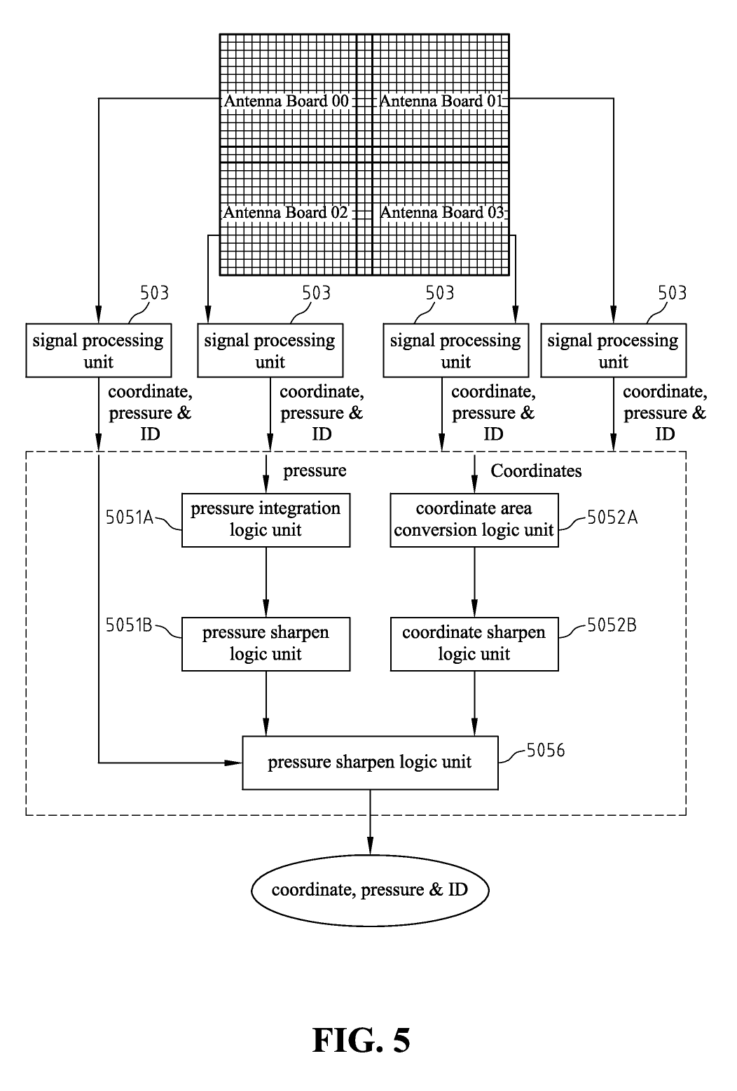

It is worth noting that pressure integration logic unit 4051A, pressure sharpen logic unit 4051B, and pressure calibration logic unit 4051C form a pressure information integration module to integrate pressure information, such as pressure 1 and pressure 2, fed to pressure integration logic unit 4051A. Similarly, coordinate area conversion logic unit 4052A, coordinate sharpen logic unit 4052B, and coordinate calibration logic unit 4052C form a coordinate information integration module to integrate coordinate information, such as coordinate 1 and coordinate 2, fed to coordinate area conversion logic unit 4052A. Antenna signal filter 4053A and antenna signal logic processing unit 4053B form an antenna signal information integration module to integrate antenna digital signals, while frequency filter 4054A and frequency logic processing unit 4054B form a frequency information integration module to integrate the frequency information. All the integrated information can be further integrated to provide higher level information, such as INK information, TABLET information, and any other specific information. As shown in FIG. 5, TABLET information integration unit 4055 can integrate pressure information, coordinate information, antenna signal information and frequency information to obtain the TABLET information for output. Similarly, INK information integration unit 4056 integrates ID information and information from TABLET information integration unit 4055 to obtain INK information for output, and specific information integration unit 4057 can integrate antenna signal information and frequency information to obtain specific information for output.

FIG. 5 shows a schematic view of a first application of the apparatus with multiple signal processing units of the present invention to a plurality of antenna board. This application shows how a large area antenna board can be formed by a plurality of smaller antenna board with the apparatus of the present invention. In this application, four antenna boards are tiled together to form a large area antenna board.

As shown in FIG. 5, antenna board 00, antenna board 01, antenna board 02, and antenna board 03 form a large area antenna board. Four signal processing units 503 are used, with each connected to an antenna board 00, 01, 02, 03. In this application, only coordinate information, pressure information and ID are used. Therefore, only pressure integration logic unit 5051A, pressure sharpen logic unit 5051B, coordinate area conversion logic unit 5052A, coordinate sharpen logic unit 5052B, and INK information integration unit 5056 of the integration processing unit are used to generate coordinate, pressure and ID information. In addition, the signals from overlapped boundary area between two neighboring antenna board can be computed by two corresponding signal processing units and then integrated by integration processing unit to obtain a more precise and accurate result. For example, the pressure information received from each signal processing unit can be determined by pressure integration logic unit 5051A for correctness, and then through the SMOOTH function of pressure sharpen logic unit 5051B to obtain a better result. Similarly, the coordinate information from each signal processing unit can be converted by coordinate area conversion logic unit 5052A to the coordinate of a correct working area, and then through the SMOOTH function of the coordinate sharpen logic unit 5052B to obtain a better coordinate. Finally, INK information integration unit 5056 integrates the ID, pressure information and coordinate information to generate the final output. In this manner, a four-fold large area antenna board can be implemented with smaller antenna boards. This overcomes the limitation imposed by the PCB manufacturing process.

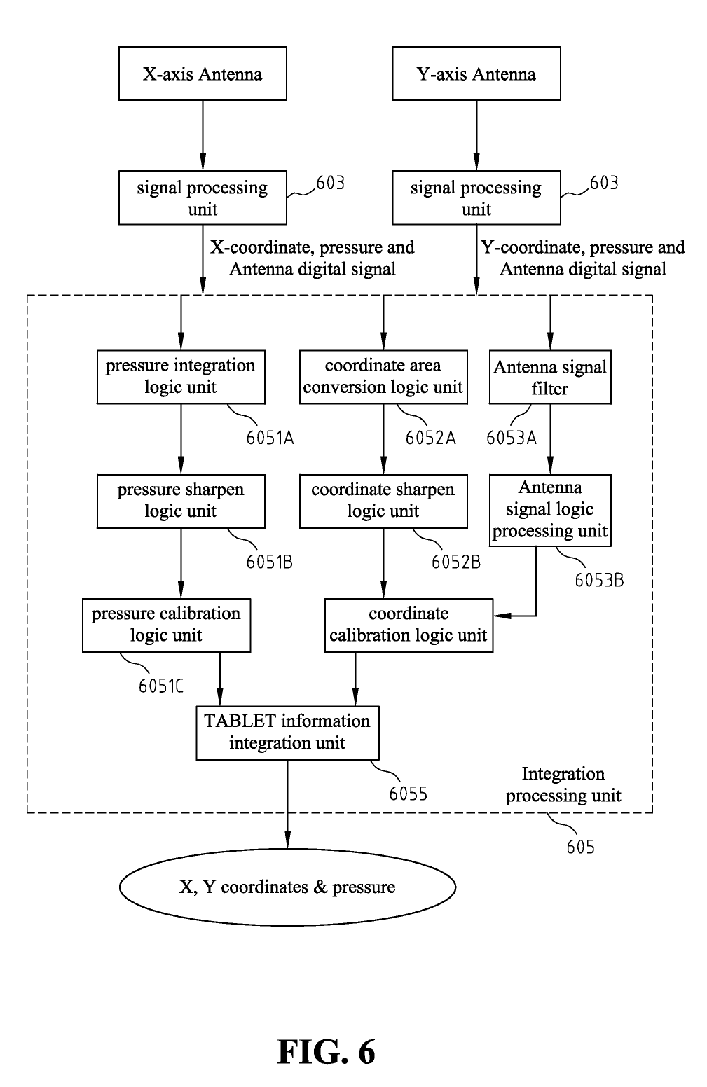

FIG. 6 shows a schematic view of a second application of the apparatus with multiple signal processing units of the present invention to a single antenna board. In this application, two signal processing units are connected to process the signals from an antenna board. The X-axis antenna of the antenna board is connected to one signal processing unit, and the Y-axis antenna is connected to the other. Thus, X-axis signal and Y-axis signal are processed concurrently and separately by a signal processing unit to improve the performance and precision. The processed X-axis and Y-axis signals are both fed to integration processing unit 605 for integration. As shown in this application, only pressure integration logic unit 6051A, pressure sharpen logic unit 6051B, pressure calibration logic unit 6051C, coordinate area conversion logic unit 6052A, coordinate sharpen logic unit 6052B, coordinate calibration logic unit 6052C, antenna signal filter 6053A, antenna signal logic processing unit 6053B, and TABLET information integration unit 6055 are included. The pressure, coordinate, antenna digital signal of the X-axis and the pressure, coordinate, antenna digital signal of the Y-axis are fed to pressure integration logic unit 6051A, coordinate area conversion logic unit 6052A, antenna signal filter 6053A respectively. Antenna signal logic processing unit 6053B performs the tilting detection, which is fed to coordinate calibration logic unit for coordinate calibration for more precise coordinates. The pressure of X-axis and the pressure of Y-axis are added by pressure integration logic unit 6051A, then through pressure sharpen logic unit and pressure calibration logic unit to obtain a more precision reading. All the information is then integrated by TABLET information integration unit to output X-Y coordinates and pressure. In this application, two signal processing units are used to improve the precision of the signal processing.

In summary, the apparatus of the present invention uses a plurality of signal processing units and an integration processing unit to process signal from at least one antenna board to improve signal processing performance. The two applications show that the present invention can be applied to the construction of a large-area antenna board or improving the coordinate/pressure computation precision of a single antenna board.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for processing signal from antenna board, comprising:
a plurality of signal processing units, each said signal processing unit connected said antenna board; and
an integration signal processing unit, connected to all said signal processing unit;
wherein each said signal processing unit processes signals sensed by said antenna board and feeds processed signal results to said integration processing unit for integration to obtain final output.

2. The apparatus as claimed in claim 1, wherein said signal processing unit further comprises:
a signal amplifier, for receiving and amplifying signal sensed by said antenna board;
a signal filter, for receiving and filtering amplified signal from said signal amplifier;
a charge/discharge circuit, for receiving and converting filtered signal to obtain antenna digital signal;
a frequency divider, for receiving said filtered signal for frequency division; and
a microprocessing unit (MCU), for computing said antenna digital signal to obtain coordinate information, and computing frequency to obtain pressure and ID information.

3. The apparatus as claimed in claim 1, wherein said integration processing unit further comprises:
a pressure integration logic unit, for integrating pressure information from each said signal processing unit;
a pressure sharpen logic unit, for performing computing functions on integrated pressure information of said pressure integration logic unit;
a pressure calibration logic unit, for calibrating pressure information from said pressure sharpen logic unit;
a coordinate area conversion logic unit, for integrating coordinate information from each said signal processing unit;
a coordinate sharpen logic unit, for performing computing functions on integrated coordinate information of said coordinate area conversion logic unit;
a coordinate calibration logic unit, calibrating coordinate information from said coordinate sharpen logic unit;
an antenna signal filter, for integrating antenna digital signal from each said signal processing unit;
an antenna signal logic processing unit, for performing computing functions on integrated antenna digital signal from said antenna signal filter, and outputting information to said coordinate calibration logic unit for coordinate calibration;
a frequency filter, for integrating frequency information from each said signal processing unit;
a frequency logic processing unit, for performing computing functions on said integrated frequency information from said frequency filter;
a TABLET information integration unit, for integrating pressure information from said pressure calibration logic unit and coordinate information from said coordinate calibration logic unit to generate a final TABLET information for output;
an INK information integration unit, for integrating said final TABLET information from said TABLET information integration unit and said ID from each said signal processing to generate a final INK information for output; and
a specific information integration unit, for integrating antenna signal information from said antenna signal logic processing unit and said frequency logic processing unit to generate a final specific information for output.

4. The apparatus as claimed in claim 2, wherein said processed signal result from said signal processing unit comprises information of pressure, coordinate, antenna digital signal, ID, frequency, I/O and parameter setting, or any combination of the above.

5. The apparatus as claimed in claim 3, wherein said final output of said integration processing unit comprises INK information, TABLET information, other specific information, or any combination of the above.

6. An apparatus for processing signal from a plurality of antenna boards, said plurality of antenna board forming a large-area antenna board, said apparatus comprising:
a plurality of signal processing units, each said signal processing unit connected to each said antenna board; and
an integration signal processing unit, connected to all said signal processing unit;
wherein each said signal processing unit processes signals sensed by each said antenna board and feeds processed signal results to said integration processing unit for integration to obtain final output.

7. The apparatus as claimed in claim 6, wherein said signal processing unit further comprises:
a signal amplifier, for receiving and amplifying signal sensed by said connected antenna board;
a signal filter, for receiving and filtering amplified signal from said signal amplifier;
a charge/discharge circuit, for receiving and converting filtered signal to obtain antenna digital signal;
a frequency divider, for receiving said filtered signal for frequency division; and
a microprocessing unit (MCU), for computing said antenna digital signal to obtain coordinate information, and computing frequency to obtain pressure and ID information.

8. The apparatus as claimed in claim 6, wherein said integration processing unit further comprises:
a pressure integration logic unit, for integrating pressure information from each said signal processing unit;
a pressure sharpen logic unit, for performing computing functions on integrated pressure information of said pressure integration logic unit;
a coordinate area conversion logic unit, for integrating coordinate information from each said signal processing unit;
a coordinate sharpen logic unit, for performing computing functions on integrated coordinate information of said coordinate area conversion logic unit; and
an INK information integration unit, for integrating pressure information from said pressure sharpen logic unit, coordinate information from said coordinate sharpen logic unit, and said ID from each said signal processing to generate a final coordinate, pressure and ID information for output.

9. The apparatus as claimed in claim 7, wherein said processed signal result from said signal processing unit comprises information of pressure, coordinate, ID, or any combination of the above.

10. An apparatus for processing signal from an antenna boards, said apparatus comprising:
a plurality of signal processing units, each said signal processing unit connected to said antenna board for processing different signal from said antenna board; and
an integration signal processing unit, connected to all said signal processing unit;
wherein each said signal processing unit processes different signals sensed by each said antenna board, comprising frequency, pressure, coordinate, ID, antenna digital signal or any combination of the above, and feeds processed signal results to said integration processing unit for integration to obtain final output.

11. The apparatus as claimed in claim 10, wherein said signal processing unit further comprises:
a signal amplifier, for receiving and amplifying signal sensed by said antenna board;
a signal filter, for receiving and filtering amplified signal from said signal amplifier;
a charge/discharge circuit, for receiving and converting filtered signal to obtain antenna digital signal;
a frequency divider, for receiving said filtered signal for frequency division; and
a microprocessing unit (MCU), for computing said antenna digital signal to obtain coordinate information, and computing frequency to obtain pressure and ID information.

12. The apparatus as claimed in claim 10, wherein said integration processing unit further comprises:
a pressure integration logic unit, for integrating pressure information from each said signal processing unit;
a pressure sharpen logic unit, for performing computing functions on integrated pressure information of said pressure integration logic unit;
a pressure calibration logic unit, for calibrating pressure information from said pressure sharpen logic unit;
a coordinate area conversion logic unit, for integrating coordinate information from each said signal processing unit;
a coordinate sharpen logic unit, for performing computing functions on integrated coordinate information of said coordinate area conversion logic unit;
a coordinate calibration logic unit, calibrating coordinate information from said coordinate sharpen logic unit;
an antenna signal filter, for integrating antenna digital signal from each said signal processing unit;
an antenna signal logic processing unit, for performing computing functions on integrated antenna digital signal from said antenna signal filter, and outputting information to said coordinate calibration logic unit for coordinate calibration; and
a TABLET information integration unit, for integrating pressure information from said pressure calibration logic unit and coordinate information from said coordinate calibration logic unit to generate a final output.

13. The apparatus as claimed in claim 11, wherein said processed signal result from said signal processing unit comprises information of pressure, coordinate, or any combination of the above.
